(19) United States
(12) Patent Application Publication
(10) Pub. No.: US 2026/0133457 A1
(43) Pub. Date: May 14, 2026

(54) DISPLAY DEVICE

(71) Applicant: Japan Display Inc., Tokyo (JP)

(72) Inventor: Gen KOIDE, Tokyo (JP)

(21) Appl. No.: 19/378,716

(22) Filed: Nov. 4, 2025

(30) Foreign Application Priority Data
Nov. 14, 2024 (JP) 2024-199159

(51) Int. Cl. G02F 1/1362

(52) U.S. Cl. CPC G02F 1/136286

(57) ABSTRACT

According to one embodiment, a display device includes a display panel and a first light-emitting part that irradiates light onto the display panel. The display panel includes a first transparent substrate, a second transparent substrate, a liquid crystal layer located between the first transparent substrate and the second transparent substrate, and a first wiring line extending in a first direction. The second transparent substrate has a first side surface, the edge of which extends along the first direction. The first light-emitting part has multiple first light-emitting elements and multiple second light-emitting elements arranged alternately along the first side surface.

### CROSS-REFERENCE TO RELATED APPLICATIONS

This application is based upon and claims the benefit of priority from Japanese Patent Application No. 2024-199159, filed November 14, 2024, the entire contents of which are incorporated herein by reference.

### FIELD

Embodiments described herein relate generally to a display device.

### BACKGROUND

In recent years, various display devices using polymer dispersed liquid crystals that can switch between a scattering state and a transparent state have been proposed. In one example, the display device comprises a display panel having a polymer dispersed liquid crystal and a light source disposed along a side surface of the transparent substrate.

Part of the illumination light emitted from the light source may be reflected at wiring lines placed perpendicular to its propagation direction. This reflection in the wiring lines is particularly pronounced in wiring lines near the light source. Such undesirable reflection leads to a deterioration in display quality. To avoid this problem, a technique of forming the wiring lines in a curved shape is known.

### BRIEF DESCRIPTION OF THE DRAWINGS

FIG. 1 is a plan view showing a configuration of a display device according to the first embodiment.

FIG. 2 is a cross-sectional view of the display device taken along the line A - B shown in FIG. 1.

FIG. 3 Is an enlarged view of a first light-emitting part shown inFIG. 1

FIG. 4 is an enlarged view of a first light-emitting element shown IN FIG. 3

FIG. 5 is an example of a layout of wiring lines portion included in a display panel shown in FIG. 1.

FIG. 6 is a cross-sectional view of the display device taken along the line C-D shown in FIG. 5.

FIG. 7 Is a partially enlarged view of the display device shown in FIG. 1.

FIG. 8 is a diagram schematically showing light-emitting elements shown in FIG. 7 irradiating light onto the display panel.

FIG. 9 is a partially enlarged view of a light guide, a first light-emitting element, and a second light-emitting element shown in FIG. 2.

FIG. 10 is another partially enlarged view of the light guide, first light-emitting element, and second light-emitting element shown in FIG. 2.

FIG. 11 is a diagram showing a layout of the wiring line portion of a display device according to a comparative example of the first embodiment.

FIG. 12 is a plan view showing a configuration of a display device according to the second embodiment.

FIG. 13 is an enlarged view of a first light-emitting element shown in FIG. 12.

FIG. 14 is a cross-sectional view of a display device according to a modified example.

FIG. 15 is a plan view of a display device according to the third embodiment.

FIG. 16 is a partially enlarged view of the display device shown in FIG. 15.

FIG. 17 is a view showing only the light-emitting elements extracted from the display device shown in FIG. 15.

FIG. 18 is a diagram schematically showing how the light-emitting elements irradiate light onto the display panel in the display device according to the third embodiment.

FIG. 19 is a plan view of a display device according to the fourth embodiment.

FIG. 20 is a diagram showing only light-emitting elements extracted from the display device shown in FIG. 19.

FIG. 21 is a diagram schematically showing how the light-emitting elements irradiate light onto the display panel in the display device according to the fourth embodiment.

### DETAILED DESCRIPTION

In general, according to one embodiment, a display device comprises a display panel and a first light-emitting part that irradiates light onto the display panel. The display panel comprises a first transparent substrate, a second transparent substrate overlapping the first transparent substrate, a liquid crystal layer containing a polymer-dispersed liquid crystal disposed between the first and second transparent substrates, a first wiring line extending along a first direction and located between the first transparent substrate and the liquid crystal layer, and a second wiring line located between the first transparent substrate and the liquid crystal layer and intersecting the first wiring line. The second transparent substrate has a first side surface, and the edge of the first side surface extends along the first direction in plan view. The first light-emitting part comprises a plurality of first light-emitting elements each having a first light-emitting surface that emits light, and a plurality of second light-emitting elements each having a second light-emitting surface that emits light. The plurality of first light-emitting elements and the plurality of second light-emitting elements are arranged alternately along the first side surface. The first normal of the first light-emitting surface extends in a direction different from both the first direction and a second direction perpendicular to the first direction. The second normal of the second light-emitting surface extends in a direction different from the first direction, the second direction, and the direction in which the first normal extends.

According to the above-described configuration, it is possible to provide a display device which can improve the display quality.

Several embodiments will be described hereinafter with reference to the accompanying drawings.

Note that the disclosure is merely an example, and proper changes within the spirit of the invention, which are easily conceivable by a skilled person, are included in the scope of the invention as a matter of course. In addition, in some cases, in order to make the description clearer, the widths, thicknesses, shapes, etc., of the respective parts are schematically illustrated in the drawings, compared to the actual modes. However, the schematic illustration is merely an example, and adds no restrictions to the interpretation of the invention. Besides, in the specification and drawings, the same or similar elements as or to those described in connection with preceding drawings or those exhibiting similar functions are denoted by like reference numerals, and a detailed description thereof is omitted unless otherwise necessary.

Furthermore, drawings include X, Y, and Z axes as necessary to facilitate understanding. The direction along the X axis is referred to as a first direction X, the direction along the Y axis is referred to as a second direction Y, and the direction along the Z axis is referred to as a third direction Z. Viewing various elements parallel to the third direction Z is referred to as a plan view. For example, the first direction X, the second direction Y, and the third direction Z are orthogonal to each other, but they may intersect at angles other than 90 degrees.

In the following descriptions, such an expression as “overlaying” refers not only to cases where one element overlaps another element from the third direction Z, but also includes cases where one element overlaps another element from a direction opposite to the third direction Z. Further, such an expression as “overlapping” refers not only to cases where the object elements are in direct contact with each other, but also includes cases where the object elements are spaced apart from each other or where some other element is located between the object elements.

Further, in the following descriptions, terms indicating the relative positions of two or more components, such as “above,” “upward,” “between,” or “facing,” include not only cases where the two or more components are in direct contact with each other, but also cases where they are separated by a gap or some other component.

In the examples shown in the figures, the display device is placed such that the first direction X aligns with the horizontal direction (left-right direction) of the display device. Further, the display device is placed such that the second direction Y aligns with the vertical direction (up-down direction) of the display device. Furthermore, the display device is placed such that the third direction Z aligns with the thickness direction of the display device. In the examples shown in the figures, the positive direction for the first direction X is to the right of the display device and display panel. The negative direction for the first direction X is to the left of the display device and display panel. In the examples shown in the figures, the positive direction for the second direction Y is upward relative to the display device and display panel. The negative direction for the second direction Y is downward relative to the display device and display panel. In the examples shown in the figures, the positive direction of the third direction Z is toward the rear (back) of the display device. The negative direction of the third direction Z is toward the front (front side) of the display device. The display device according to the embodiment displays images toward the front side.

### First Embodiment

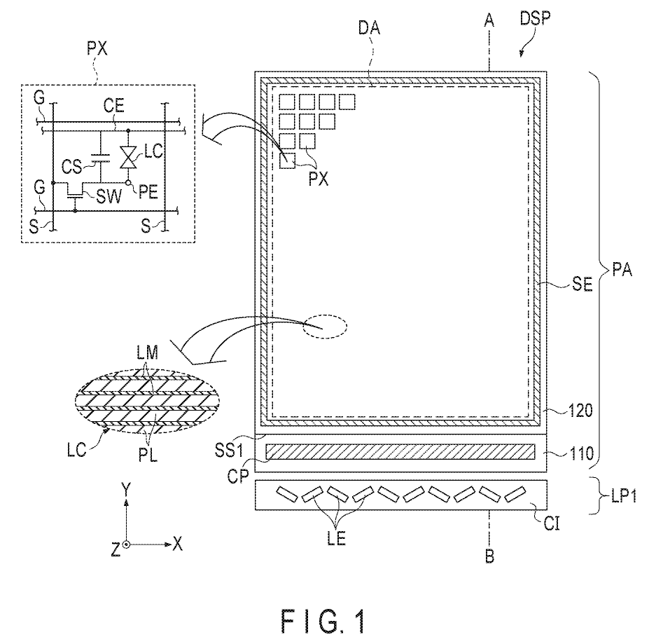

FIG. 1 is a plan view showing a configuration of a display device DSP according to the first embodiment. The display device DSP comprises a display panel PA and a first light-emitting part LP1. The display panel PA comprises a first transparent substrate 110, a second transparent substrate 120, a liquid crystal layer LC, and a seal SE. The first transparent substrate 110 and the second transparent substrate 120 are each formed as a flat plate parallel to an X-Y plane defined by the first direction X and the second direction Y, and are overlaid on each other in plan view. The first transparent substrate 110 extends further in the second direction Y than the second transparent substrate 120. In the example illustrated, both the first transparent substrate 110 and the second transparent substrate 120 are formed as quadrilaterals, but their shapes are not limited to these. For example, the first transparent substrate 110 and the second transparent substrate 120 may have any shape, such as a polygon other than a quadrilateral, a circle, an ellipse, or a semicircle.

The second transparent substrate 120 has a first side surface SS1, and an edge of the first side surface SS1 extends along the first direction X in plan view.

The liquid crystal layer LC is located between the first transparent substrate 110 and the second transparent substrate 120 and is sealed by the seal SE. In the example shown schematically and enlarged in FIG. 1, the liquid crystal layer LC comprises a polymer dispersed liquid crystal containing polymers PL and liquid crystal molecules LM. In one example, the polymers PL are liquid crystalline polymer formed into filaments extending along the first direction X. The liquid crystal molecules LM are dispersed in the gaps between the polymers PL and are aligned such that their longitudinal axes are placed along the first direction X. Both the polymers PL and the liquid crystal molecules LM exhibit optical anisotropy or refractive index anisotropy. The response of the polymers PL to an electric field is lower than that of the liquid crystal molecules LM.

In one example, the alignment direction of the polymers PL remains substantially unchanged regardless of the presence or absence of an electric field. On the other hand, the alignment direction of the liquid crystal molecules LM changes according to the electric field when a voltage at a threshold or higher is being applied to the liquid crystal layer LC. When no voltage is applied to the liquid crystal layer LC, the optical axes of the polymers PL and those of the liquid crystal molecules LM are parallel to each other. With this configuration, light entering the liquid crystal layer LC passes therethrough without being scattered in the liquid crystal layer LC (transparent state). When a voltage is being applied to the liquid crystal layer LC, the optical axes of the polymers PL and those of the liquid crystal molecules LM intersect each other. With this configuration, light entering the liquid crystal layer LC is scattered within the liquid crystal layer LC (scattering state).

Note that the composition of the polymer-dispersed liquid crystal containing the polymers PL and liquid crystal molecules LM is not limited to that of the example provided above.

The display panel PA has a display area DA that displays images. The display area DA includes a plurality of pixels PX arranged in a matrix pattern along the first direction X and the second direction Y. In the example illustrated, the display area DA is formed into a rectangle shape indicated by dashed lines, but the shape of the display area DA is not limited to this. For example, the display area DA may have any shape, such as a polygon other than a rectangle, a circle, an ellipse, or a semicircle.

As enlarged and shown in FIG. 1, each of the pixels PX contains a switching element SW, a pixel electrode PE, a common electrode CE, a liquid crystal layer LC, and the like. The switching element SW is constituted, for example, by a thin-film transistor (TFT) and is electrically connected to a respective scanning line G (first wiring line) and a respective signal line S (second wiring line). The scanning lines G each extend along the first direction X and are each electrically connected to the switching element SW in the respective one of the pixels PX arranged along the first direction X. The signal lines S extend along the second direction Y, intersect the scanning lines G, and are each electrically connected to the switching element SW in the respective one of the pixels PX arranged along the second direction Y. In the example shown in the figure, the signal lines S and the scanning lines G are orthogonal to each other, but the direction of extension of the signal lines S is not limited to this. In other words, the signal lines S may extend in a direction different from the second direction Y. The pixel electrodes PE are electrically connected to the switching elements SW, respectively. Each of the pixel electrodes PE faces the common electrode CE, and drives the liquid crystal layer LC (specifically, the liquid crystal molecules LM) by the electric field generated between the pixel electrode PE and the common electrode CE. A capacitance CS is formed, for example, between an electrode at the same potential as that of the common electrode CE and an electrode at the same potential as that of the pixel electrode PE.

The scanning lines G, signal lines S, switching elements SW, and pixel electrodes PE are formed between the first transparent substrate 110 and the liquid crystal layer LC. The common electrode CE is formed between the second transparent substrate 120 and the liquid crystal layer LC.

The IC chip CP and a flexible printed circuit board (not shown) are mounted on the first transparent substrate 110.

The first light-emitting part LP1 is configured to emit illumination light for illuminating the liquid crystal layer LC toward the display panel PA. The first light-emitting part LP1 faces the first side surface SS1 of the display panel PA.

The first light-emitting part LP1 comprises a plurality of light-emitting elements LE and a circuit board CI. These light-emitting elements LE are mounted on the circuit board CI. Further, the light-emitting elements LE are arranged at intervals along the first side surface SS1 of the second transparent substrate 120. In other words, the light-emitting elements LE are arranged at intervals along the first direction X.

The light-emitting elements LE, though not described in detail, include a red light-emitting part, a green light-emitting part, and a blue light-emitting part. The red, green, and blue light-emitting parts may be lit sequentially or all at the same time.

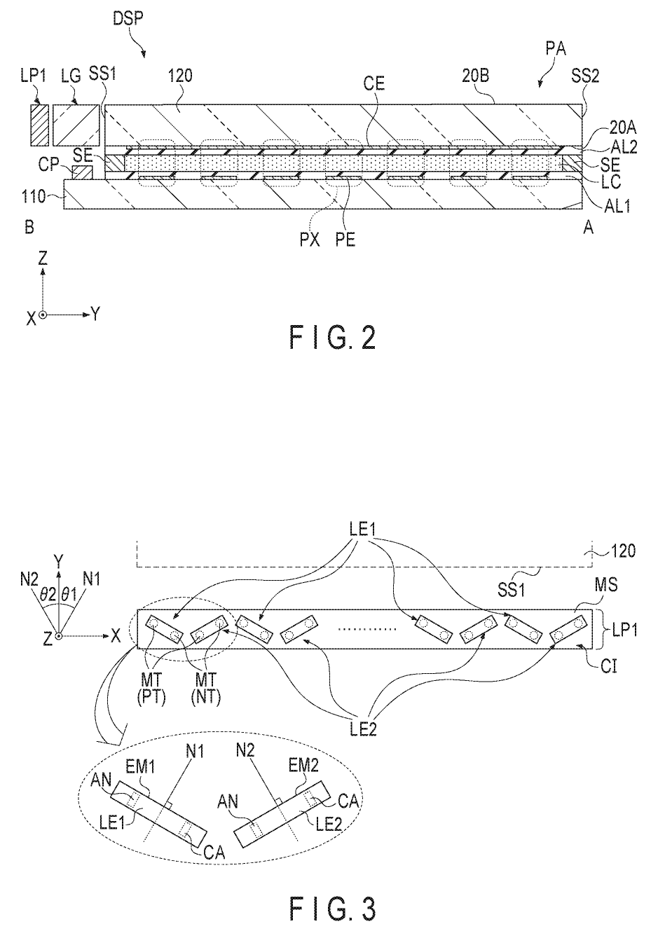

FIG. 2 is a cross-sectional view of the display device DSP taken along the line A-B shown in FIG. 1. The first transparent substrate 110 and the second transparent substrate 120 are, for example, glass substrates, but may as well be resin substrates.

The second transparent substrate 120 has a main surface 20A and a surface 20B. The main surface 20A faces the first transparent substrate 110 along the third direction Z. The rear surface 20B is located on an opposite side to the main surface 20A. The first side surface SS1 connects the main surface 20A and the rear surface 20B to each other. The second transparent substrate 120 has a second side surface SS2. The second side surface SS2 is located on an opposite side to the first side surface SS1 and connects the main surface 20A and the rear surface 20B to each other. The first side surface SS1 and the second side surface SS2 are each parallel to an X-Z plane defined by the first direction X and the third direction Z.

The liquid crystal layer LC is located between the first transparent substrate 110 and the second transparent substrate 120. The pixel electrode PE of each of the pixels PX is located between the first transparent substrate 110 and the liquid crystal layer LC, and is covered by a first alignment film AL1. The common electrode CE, which faces multiple pixel electrodes PE, is located between the second transparent substrate 120 and the liquid crystal layer LC, and is covered by a second alignment film AL2. The liquid crystal layer LC is in contact with both the first alignment film AL1 and the second alignment film AL2. The pixel electrodes PE and common electrode CE are transparent electrodes formed from a transparent conductive material, such as indium tin oxide (ITO).

The display device DSP further comprises a light guide LG located between the second transparent substrate 120 and the first light-emitting part LP1. The light guide LG is formed, for example, from glass or resin. The light guide LG faces the first side surface SS1 via an air layer.

The first light-emitting part LP1 is shown in FIG. 2in such a manner that the configuration thereof is partially simplified. The first light-emitting part LP1 is configured to emit illumination light toward the second transparent substrate 120. The illumination light emitted from the first light-emitting part LP1 first enters the light guide LG and then passes therethrough. The illumination light having passed through the light guide LG enters the second transparent substrate 120 through the first side surface SS1.

The second transparent substrate 120 functions as a light guide plate that propagates the illumination light along the second direction Y. In one example, the illumination light entering through the first side surface SS1 propagates within the display panel PA while repeatedly reflecting totally between the outer surface of the first transparent substrate 110 (the interface between the transparent substrate and air) and the outer surface of the second transparent substrate 120. Part of the propagated illumination light is output from the main surface 20A. The illumination light output from the main surface 20A then reaches the liquid crystal layer LC. The light having reached the liquid crystal layer LC is used to display the image.

FIG. 3 is an enlarged view of the first light-emitting part LP1 shown in FIG. 1 In FIG. 3, the configuration of the first light-emitting part LP1 is partially omitted. The first light-emitting part LP1 includes a circuit board CI and a plurality of light-emitting elements LE. The light-emitting elements LE are mounted on a mounting surface MS of the circuit board CI. The plurality of light-emitting elements LE includes a plurality of first light-emitting elements LE1 and a plurality of second light-emitting elements LE2.

The first light-emitting elements LE1 and the second light-emitting elements LE2 are arranged alternately along the first side surface SS1 of the second transparent substrate 120. In other words, the first light-emitting elements LE1 and the second light-emitting elements LE2 are arranged alternately along the first direction X.

As shown in FIG. 3in a further enlarged manner, the first light-emitting elements LE1 each have a first light-emitting surface EM1 that emits light. The second light-emitting elements LE2 each have a second light-emitting surface EM2 that emits light. In the example shown in FIG. 3 the first light-emitting surface EM1 and the second light-emitting surface EM2 are each perpendicular to the mounting surface MS. The first light-emitting element LE1 and the second light-emitting element LE2 each have an anode AN and a cathode CA on the surface facing the mounting surface MS.

A first normal N1, which is a straight line perpendicular to the first light-emitting surface EM1, extends in a direction different from the first direction X and the second direction Y. The first normal N1 is inclined clockwise by a first angle θ1 with reference to the second direction Y in plan view.

A second normal N2, which is a straight line perpendicular to the second light-emitting surface EM2, extends in a direction different from the first direction X, the second direction Y, and the first normal N1. The second normal N2 is inclined at a second angle θ2 counterclockwise with respect to the second direction Y in plan view. Both the first angle θ1 and the second angle θ2 are greater than 0 degrees and less than or equal to 45 degrees. In one example, the first angle θ1 and the second angle θ2 are equal to each other.

In the example illustrated, the first normal N1 is inclined toward the right side of the display device DSP, and the first light-emitting surface EM1 faces the right side of the display device DSP. On the other hand, the second normal N2 is inclined toward the left side of the display device DSP, and the second light-emitting surface EM2 faces the left side of the display device DSP. That is, on the circuit board CI, the first light-emitting elements LE1 facing the right side of the display device DSP and the second light-emitting elements LE2 facing the left side of the display device DSP are arranged alternately.

On the mounting surface MS, a plurality of mounting terminals MT is provided. The mounting terminals MT include positive terminals PT and negative terminals NT. The first light-emitting elements LE1 and the second light-emitting elements LE2 are mounted on the mounting surface MS of the circuit board CI via the mounting terminals MT. In the example illustrated, each one light-emitting element LE is mounted on the circuit board CI via one positive terminal PT and one negative terminal NT.

The anode AN of one first light-emitting element LE1 is electrically connected to the respective positive terminal PT, and the cathode CA of one first light-emitting element LE1 is electrically connected to the respective negative terminal NT. The anode AN of one second light-emitting element LE2 is electrically connected to the respective positive terminal PT, and the cathode CA of one second light-emitting element LE2 is electrically connected to the respective negative terminal NT.

The plurality of first light-emitting elements LE1 and the plurality of second light-emitting elements LE2 overlap the circuit board CI in plan view. The mounting terminals MT are located between the circuit board CI and the respective light-emitting elements LE. In plan view, the mounting terminals MT are arranged in a zigzag pattern on the mounting surface MS. With this arrangement, the positive terminals PT and the negative terminals NT are alternately arranged in plan view. A pair of a positive terminal PT and a negative terminal NT are arranged diagonally (in a direction intersecting the first direction X and the second direction Y) on the mounting surface MS. In the display device DSP according to the first embodiment, the orientations of the first normal N1 and the second normal N2 can be adjusted by the layout of the mounting terminals MT. In other words, in the display device DSP according to the first embodiment, it is possible to determine the layout of the mounting terminals MT according to the required orientations of the first normal N1 and second normal N2.

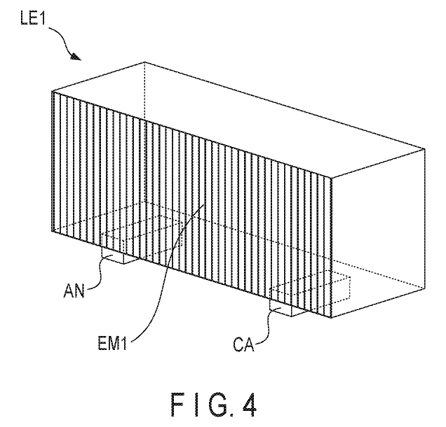

FIG. 4 is an enlarged view of the first light-emitting element LE1 shown in FIG. 3. With reference to FIG. 4 the configuration of the light-emitting element LE will be described.FIG. 4 shows one first light-emitting element LE1 as an example, but the other first light-emitting elements LE1 and the second light-emitting elements LE2 also have a similar configuration.

FIG. 4 , the first light-emitting surface EM1 is indicated by vertical stripes. Here, the first light-emitting element LE1 has an anode AN and a cathode CA on the surface adjacent to the first light-emitting surface EM1. That is, the mounting terminals MT shown in FIG. 3 are in contact with the first light-emitting element LE1 on the surface adjacent to the first light-emitting surface EM1. With this side-view configuration, when the first light-emitting element LE1 is mounted on the circuit board CI, the first light-emitting surface EM1 and the mounting surface MS are perpendicular to each other.

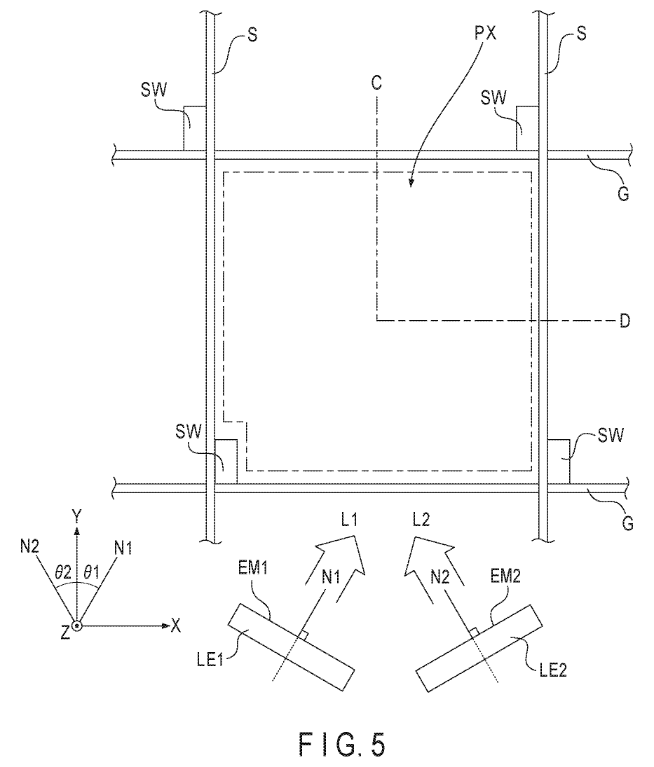

FIG. 5 is an example of the layout of the wiring line portion included in the display panel PA. The scanning lines G each extend along the first direction X and are arranged along the second direction Y. The signal lines S each extend along the second direction Y and are arranged along the first direction X. The switching elements SW, shown here in simplified form, are each positioned at the intersections of the respective one of the scanning lines G and the respective one of the signal lines S.

Light L1 (white arrow in the figure) emitted from the first light-emitting surface EM1 of the first light-emitting element LE1 primarily propagates along the first normal N1. In other words, the light L1 travels at an angle to the right relative to the display panel PA.

Light L2 (white arrow in the figure) emitted from the second light-emitting surface EM2 of the second light-emitting element LE2 primarily propagates along the second normal N2. In other words, the light L2 travels at an angle to the left relative to the display panel PA.

At this point, the light L1 and the light L2 do not substantially intersect perpendicular to the scanning line G. With this configuration, the illumination light emitted from the first light-emitting element LE1 and the second light-emitting element LE2 onto the display panel PA is suppressed from reflecting at the scanning line G. That is, the display quality of the images displayed by the display device DSP is improved.

Further, in the display device DSP according to the first embodiment, the wiring length can be shortened compared to the case where the wiring lines are curved. With this configuration, the resistance increase of the wiring lines and the increase in capacitance can be suppressed, and therefore it is possible to improve the display quality and reduce the power consumption.

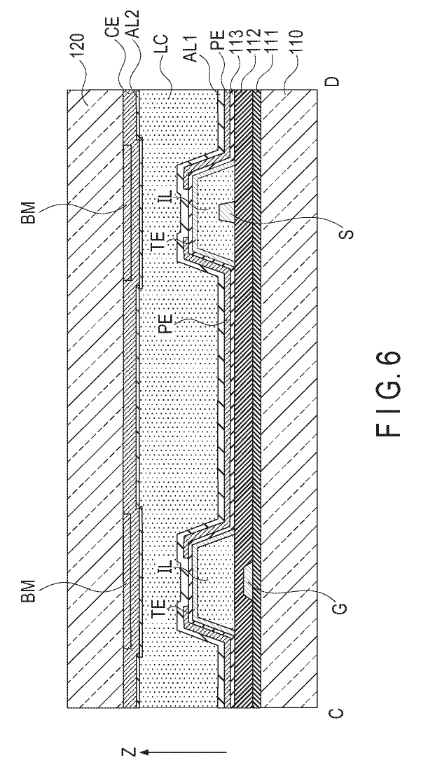

FIG. 6 s across-sectional view of the display device DSP taken along the line C-D shown in FIG. 5. An insulating layer 111 is disposed on the first transparent substrate 110. The scanning lines G are disposed on the insulating layer 111. An insulating layer 112 is disposed on the insulating layer 111. These insulating layers 111 and 112 are inorganic insulating layers formed, for example, from silicon oxide, silicon nitride, or silicon oxynitride. An insulating layer IL is placed on the insulating layer 112. The insulating layer IL is an organic insulating layer. A transparent electrode TE covers the insulating layer IL. An insulating layer 113 is placed on the insulating layer 112 and covers the transparent electrode TE. The pixel electrode PE is placed on the insulating layer 113. The insulating layer 113 is interposed between the transparent electrode TE and the pixel electrode PE. The first alignment film AL1 covers the pixel electrode PE and the insulating layer 113 and is in contact with the liquid crystal layer LC.

The scanning lines G are disposed on the insulating layer 111 and covered by the insulating layer 112. The scanning lines G are configured to have a stacked multilayer structure, for example, constituted by an aluminum layer formed from an aluminum-based material and a titanium layer formed from a titanium-based material.

The signal lines S are disposed on the insulating layer 112 and covered by the insulating layer IL. The signal lines S are configured to have a stacked multilayer structure, for example, constituted by a titanium layer and an aluminum layer.

Note that the materials for forming the scanning lines G and the signal lines S are not limited to those of the example provided above. For example, the signal lines S may include a molybdenum layer formed from a molybdenum-based material.

The light-shielding layers BM are disposed between the second transparent substrate 120 and the liquid crystal layer LC. Further, the light-shielding layers BM are located directly above the respective scanning lines G and the respective signal lines S. Although not shown, the light-shielding layers BM are also disposed directly above the switching elements SW, respectively.

The common electrode CE faces the pixel electrodes PE along the third direction Z and covers the light-shielding layers BM. The second alignment film AL2 covers the common electrode CE and is in contact with the liquid crystal layer LC.

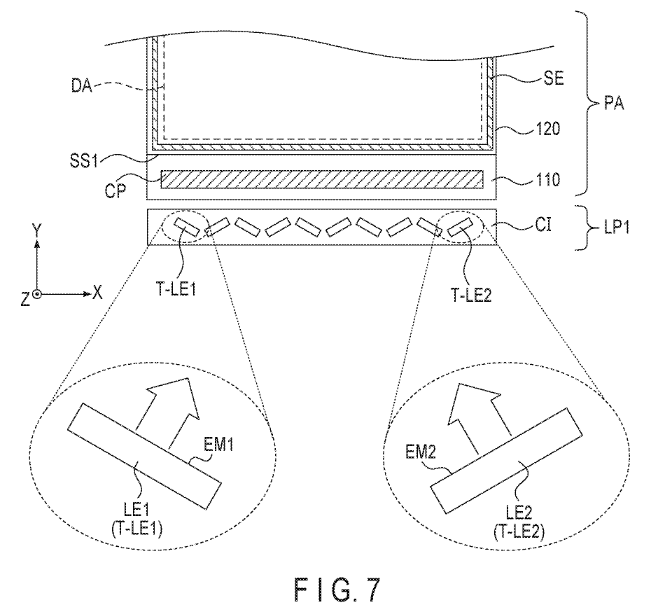

FIG. 7s a partially enlarged view of the display device DSP shown in FIG. 1. With reference to FIG. 7the arrangement of the light-emitting elements LE in the first light-emitting part LP1 will be described in further detail. As described earlier, in the first light-emitting part LP1, the first light-emitting elements LE1 and the second light-emitting elements LE2 are arranged alternately along the first direction X to form a row.

Here, let us focus on the light-emitting elements LE located at the ends of the row. As further enlarged in FIG. 7the light-emitting element T-LE1 located at the left end of the row is one of the plurality of first light-emitting elements LE1. That is, the light-emitting element T-LE1 emits illumination light inclined to the right, directed from the left end of the display device DSP toward the display area DA. Further, the light-emitting element T-LE2 located at the right end of the row is one of the plurality of second light-emitting elements LE2. That is, the light-emitting element T-LE2 emits illumination light inclined to the left, directed from the right end of the display device DSP toward the display area DA.

In other words, as to the light-emitting element T-LE1, as the location progresses in the positive direction of the first direction X, the distance between the light-emitting surface and the first side surface SS1 increases. Further, as to the light-emitting element T-LE2, as the location progresses in the positive direction of the first direction, the distance between the light-emitting surface and the first side surface SS1 decreases.

In other words, the light-emitting element T-LE1 faces the second light-emitting element LE2 adjacent thereto along the first direction X. Similarly, the light-emitting element T-LE2 faces the first light-emitting element LE1 adjacent thereto along the first direction X.

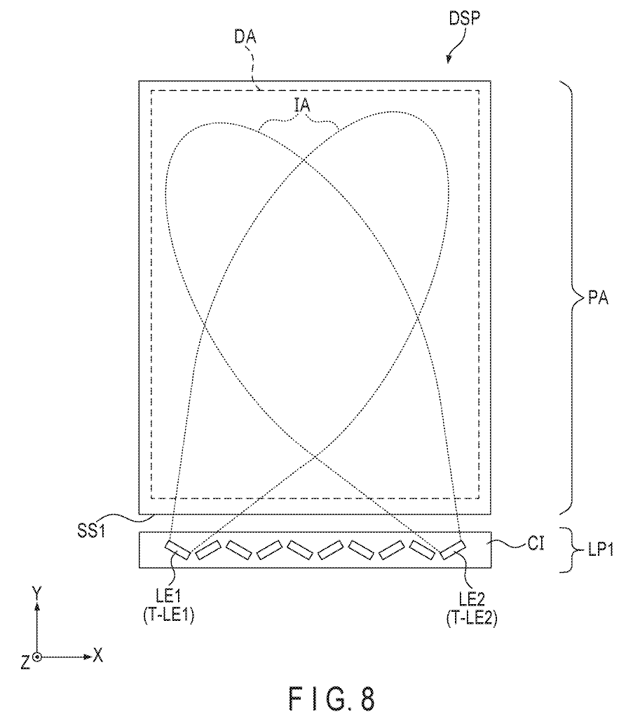

FIG. 8 is a diagram schematically showing the light-emitting elements T-LE1 and T-LE2, as shown in FIG. 7, irradiating light onto the display panel PA. In FIG. 8 the display panel PA is shown in a manner that the configuration thereof is partially omitted. InFIG. 8 the irradiation area IA is represented by a dotted line. The irradiation area IA is the area illuminated by the illumination light emitted from the light-emitting elements T-LE1 and T-LE2.

In the display device DSP shown in the example, the light-emitting element T-LE1 emits the illumination light toward the display area DA, inclined to the right. At this time, most of the irradiation area IA of the light-emitting element T-LE1 is contained within the display area DA. Therefore, compared to the case where the light-emitting element LE positioned at the leftmost end of the row is the second light-emitting element LE2 rather than the first light-emitting element LE1, the display device DSP according to the first embodiment achieves improved brightness.

Further, in the display device DSP shown in the example, the light-emitting element T-LE2 emits illumination light inclined to the left toward the display area DA. At this time, the most of the irradiation area IA of the light-emitting element T-LE2 is contained within the display area DA of the display panel PA. Therefore, compared to the case where the light-emitting element LE located at the rightmost end of the row is the first light-emitting element LE1 rather than the second light-emitting element LE2, the display device DSP according to the first embodiment exhibits improved brightness.

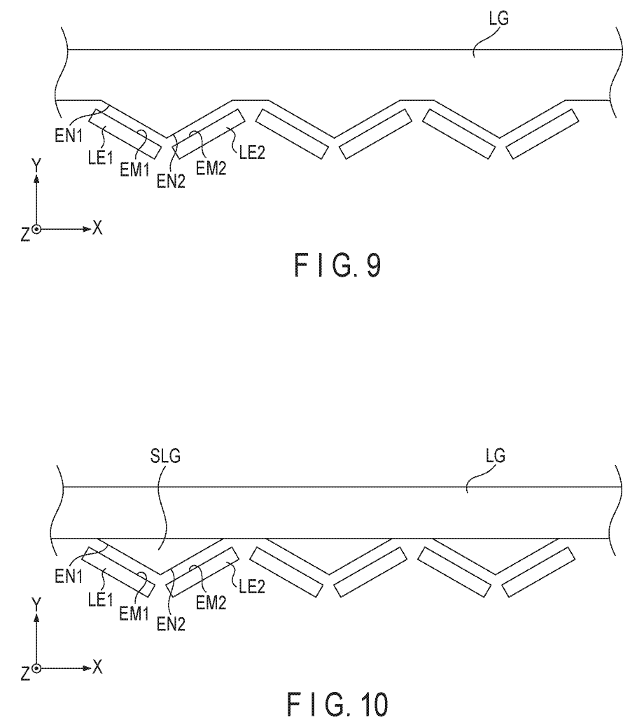

FIG. 9 and FIG. 10 are diagrams illustrating examples of the preferred shape of the light guide LG shown in FIG. 2

FIG. 9 shows one configuration example of the light guide LG of the first embodiment. The light guide LG has a first light-entering surface EN1 and a second light-entering surface EN2. The first light-entering surface EN1 is parallel to the first light-emitting surface EM1, and the second light-entering surface EN2 is parallel to the second light-emitting surface EM2. Illumination light emitted from the first light-emitting surface EM1 enters the light guide LG along the direction of the normal line of the first light-entering surface EN1. Illumination light emitted from the second light-emitting surface EM2 enters the light guide LG along the direction of the normal line of the second light-entering surface EN2.

With this configuration, the reflection of the illumination light emitted from the first light-emitting element LE1 at the first light-entering surface EN1 can be suppressed. Further, the reflection of the illumination light emitted from the second light-emitting element LE2 at the second light-entering surface EN2 as well can be suppressed. Therefore, the illumination light emitted from both the first light-emitting element LE1 and the second light-emitting element LE2 efficiently enters the light guide LG. Thus, the display panel PA can be illuminated with high-luminance illumination light.

FIG. 10 shows another configuration example of the light guide LG in the first embodiment. In the example shown in FIG. , the display device DSP further includes a separate auxiliary light guide SLG in addition to the light guide LG. The auxiliary light guide SLG is made of the same material as that of the light guide LG. The auxiliary light guide SLG is bonded to the light guide LG using a transparent adhesive. The refractive index of the adhesive is equivalent to the refractive indices of the auxiliary light guide SLG and the light guide LG. With this configuration, undesirable reflections between the auxiliary light guide SLG and the light guide LG can be suppressed.

The auxiliary light guide SLG has a first light-entering surface EN1 parallel to the first light-emitting surface EM1 and a second light-entering surface EN2 parallel to the second light-emitting surface EM2. Further, the auxiliary light guide SLG is brought into contact with the light guide LG at the surface connecting the first light-entering surface EN1 and the second light-entering surface EN2 to each other. With the configuration shown in FIG. 10, advantageous effects similar to those of the configuration shown in FIG. 9 can be achieved. That is, the illumination light emitted from the first light-emitting element LE1 and the second light-emitting element LE2 efficiently enters the light guide LG. Consequently, the display panel PA can be illuminated with high-luminance illumination light.

### Comparative Example

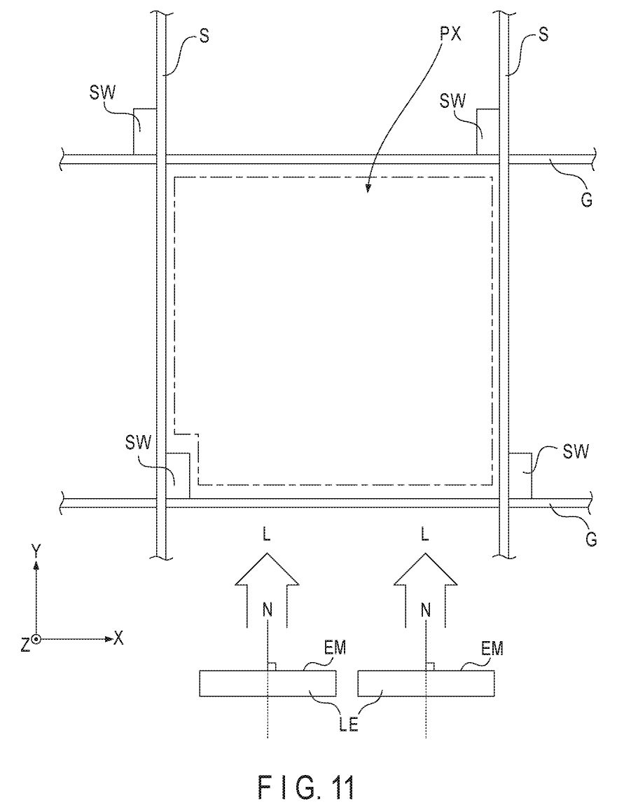

FIG. 11 is a diagram showing the layout of the wiring line portion in the display device DSP1 according to a comparative example of the first embodiment. The display device DSP1 according to the comparative example has a display panel PA having a configuration similar to that of the first embodiment.

As shown in FIG. 11, in the display device DSP1 of the comparative example, the normal lines N, which are straight line perpendicular to the light-emitting surfaces EM of the respective light-emitting elements LE, extend along the second direction Y.

Light L (white arrows in the figure) emitted from the light-emitting surfaces EM primarily propagates along the normal lines N, respectively. That is, the direction of propagation of the light L is substantially perpendicular to the scanning lines G extending along the first direction X. With this configuration, the illumination light irradiated onto the display panel PA is likely to reflect at the scanning lines G and leak outside the display panel. This can be a factor causing a deterioration in display quality.

On the other hand, in the display device DSP according to the first embodiment, the first normal N1 is inclined clockwise in plan view, with respect to the second direction Y. Further, in the display device DSP according to the first embodiment, the second normal N2 is inclined counterclockwise in plan view, with respect to the second direction Y (see FIG. 5). Therefore, as described above, the display device DSP according to the first embodiment can suppress the reflection of illumination light at the scanning lines G. Thus, it is possible to improve the display quality of images to be displayed by the display device DSP.

### Second Embodiment

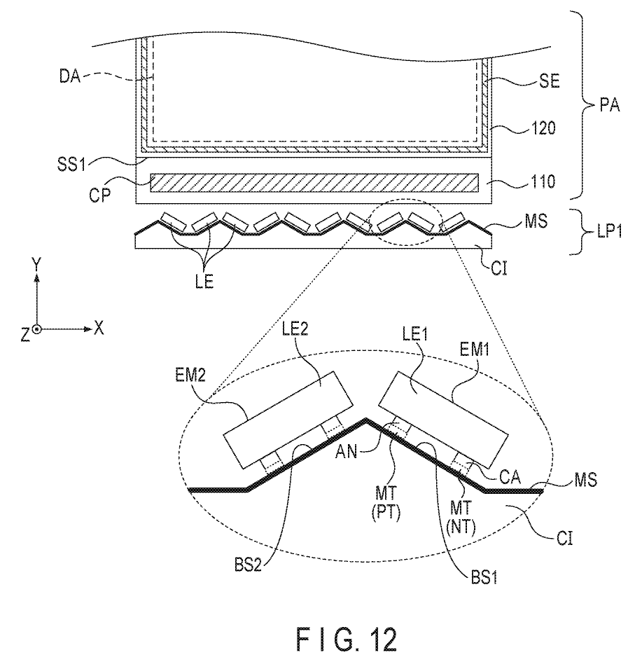

FIG. 12 is a plan view showing the configuration of a display device DSP according to the second embodiment. The second embodiment is different from the first embodiment in that the first light-emitting element LE1 and the second light-emitting element LE2 are mounted on an inclined mounting surface MS. The following description mainly discusses these differences, and other components are similar to those in the first embodiment, and detailed explanations therefor may be omitted.

The mounting surface MS of the circuit board CI has a first inclined surface BS1 and a second inclined surface BS2. The first inclined surface BS1 is the surface where the first light-emitting element LE1 is mounted. The second inclined surface BS2 is the surface where the second light-emitting element LE2 is mounted. The first inclined surface BS1 is parallel to the first light-emitting surface EM1. The second inclined surface BS2 is parallel to the second light-emitting surface EM2.

FIG. 13 is an enlarged view of the first light-emitting element LE1 shown in FIG. 12. With reference to FIG. 13, the configuration of the light-emitting element LE will be described. FIG. 13 shows one first light-emitting element LE1 as an example but note that the other first light-emitting elements LE1 and second light-emitting elements LE2 also have a similar configuration.

In FIG. 13, the first light-emitting surface EM1 is indicated by vertical stripes. Here, the first light-emitting element LE1 has an anode AN and a cathode CA on the surface located on an opposite side to the first light-emitting surface EM1. That is, the mounting terminal MT is in contact with the first light-emitting element LE1 on the surface located on the opposite side to the first light-emitting surface EM1. With such a top-view structure, when the first light-emitting element LE1 is mounted on the circuit board CI, the first light-emitting surface EM1 and the mounting surface MS are made parallel to each other.

Therefore, according to the second embodiment, advantageous effects similar to those of the first embodiment can be achieved. That is, with the display device DSP according to the second embodiment, it is possible to suppress the reflection of illumination light at the scanning lines G. Consequently, the display quality of the images displayed by the display device DSP is improved.

### Modified Example

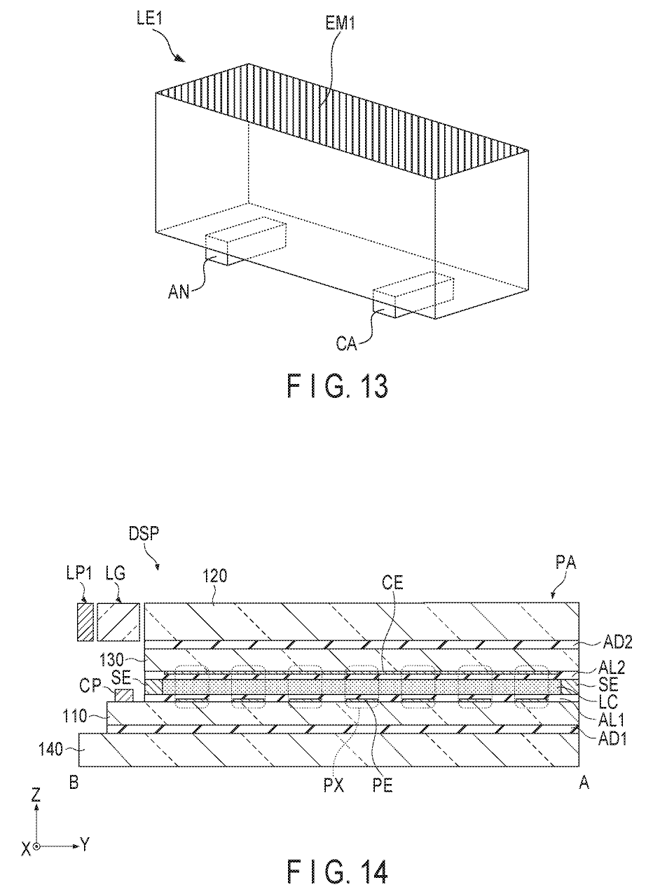

FIG. 14 is a cross-sectional view of the display device DSP according to a modified example. The display device DSP according to the modified example includes a first light-emitting part LP1 and a light guide LG, similar to those of the first embodiment. In FIG. 14, the first light-emitting part LP1 is shown in a manner that the configuration thereof partially simplified.

The display device DSP according to the modified example has a display panel PA. The display panel PA of the modified example is different from the display panel of the first embodiment in that it further includes a third transparent substrate 130 and a fourth transparent substrate 140. The first transparent substrate 110, the second transparent substrate 120, the third transparent substrate 130, and the fourth transparent substrate 140 are each formed as a flat plate parallel to the X-Y plane defined by the first direction X and the second direction Y, and they overlap each other along the third direction Z. The third transparent substrate 130 and the fourth transparent substrate 140 are, for example, glass substrates, but may as well be resin substrates.

The liquid crystal layer LC is sealed between the first transparent substrate 110 and the third transparent substrate 130 by a seal SE.

The pixel electrode PE of each of the pixels PX is located between the first transparent substrate 110 and the liquid crystal layer LC, and is covered by the first alignment film AL1. The common electrode CE, which faces multiple pixel electrodes PE, is located between the third transparent substrate 130 and the liquid crystal layer LC, and is covered by the second alignment film AL2. The liquid crystal layer LC is in contact with the first alignment film AL1 and the second alignment film AL2.

The fourth transparent substrate 140 is provided on an outer side of the first transparent substrate 110. The fourth transparent substrate 140 and the first transparent substrate 110 are adhered together by a first adhesive layer AD1 located between the two substrates. The fourth transparent substrate 140 functions, for example, as a cover member.

The second transparent substrate 120 is provided on an outer side of the third transparent substrate 130. The second transparent substrate 120 and the third transparent substrate 130 are adhered together by a second adhesive layer AD2 located between the two substrates. In this configuration example, the second transparent substrate 120 functions as a cover member and is thicker than the first transparent substrate 110 and the third transparent substrate 130, which sandwich the liquid crystal layer LC therebetween.

The first adhesive layer AD1 and the second adhesive layer AD2 have a refractive index equivalent to those of the first transparent substrate 110, the second transparent substrate 120, the third transparent substrate 130, and the fourth transparent substrate 140. With this configuration, between the second transparent substrate 120 and the third transparent substrate 130, undesirable interface reflection is suppressed. Further, undesirable interface reflection is suppressed between the first transparent substrate 110 and the fourth transparent substrate 140 as well.

With the modified example, advantageous effects similar to those of the first embodiment can be achieved. That is, the display device DSP according to the modified example can suppress reflection of the illumination light at the scanning lines G. Consequently, the display quality of the images displayed by the display device DSP is improved.

The display device DSP according to the modified example may have a light-emitting part similar to that of the display device according to the first embodiment. That is, the display device DSP according to the modified example may have light-emitting elements LE having a side-view structure similar to those shown in the first embodiment. Further, the display device DSP according to the modified example may have a light-emitting part similar to that of the display device according to the second embodiment. That is, the display device DSP according to the modified example may have light-emitting elements LE having a top-view structure similar to those shown in the second embodiment.

### Third Embodiment

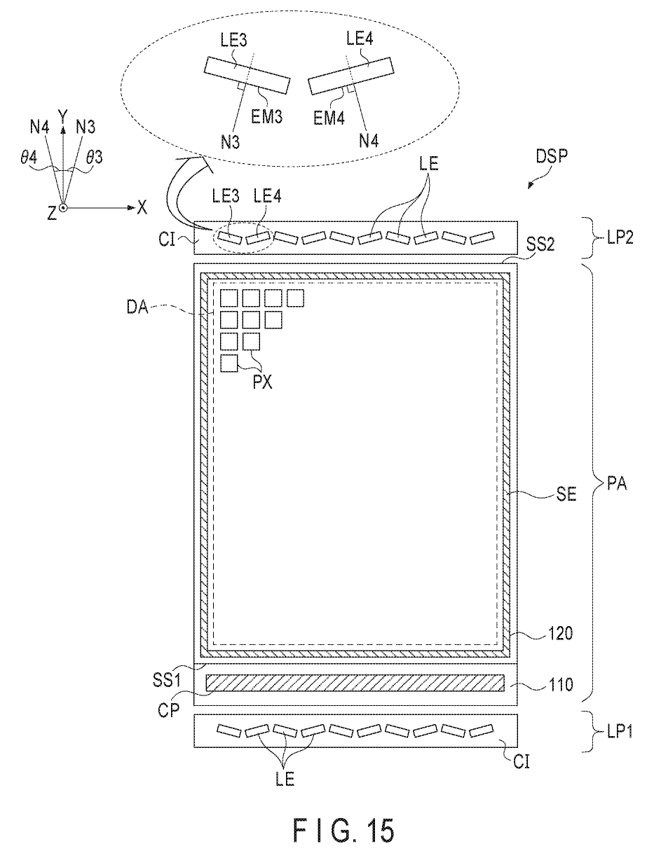

FIG. 15 is a plan view of a display device DSP according to the third embodiment. The display device DSP according to the third embodiment has a first light-emitting part LP1 and a display panel PA, similar to those of the first embodiment.

The display device DSP according to the third embodiment further includes a second light-emitting part LP2. The second light-emitting part LP2 is located on an opposite side to the first light-emitting part LP1, while interposing the display panel PA therebetween.

The second light-emitting part LP2 may be configured to be similar to the first light-emitting part LP1. That is, the second light-emitting part LP2 is configured to emit illumination light for illuminating the liquid crystal layer LC onto the display panel PA. The second light-emitting part LP2 comprises a plurality of light-emitting elements LE and a circuit board CI. The light-emitting elements LE are mounted on the circuit board CI. Furthermore, the second light-emitting part LP2 faces a second side surface SS2 of the display panel PA.

The light-emitting elements LE are configured to irradiate illumination light onto the second side surface SS2 of the second transparent substrate 120. The light-emitting elements LE provided in the second light-emitting part LP2 include a plurality of third light-emitting elements LE3 and a plurality of fourth light-emitting elements LE4.

The third light-emitting elements LE3 and the fourth light-emitting elements LE4 are arranged alternately along the second side surface SS2 of the second transparent substrate 120. In other words, the third light-emitting elements LE3 and the fourth light-emitting elements LE4 are arranged alternately along the first direction X.

The third light-emitting element LE3 has a third light-emitting surface EM3 that emits light. The fourth light-emitting element LE4 has a fourth light-emitting surface EM4 that emits light. The third light-emitting element LE3 and the fourth light-emitting element LE4 may have the side-view structure illustrated in the first embodiment. The third light-emitting element LE3 and the fourth light-emitting element LE4 may as well have the top view structure illustrated in the second embodiment.

The third normal N3, which is a straight line perpendicular to the third light-emitting surface EM3, extends in a direction different from the first direction X and the second direction Y. The third normal N3 is inclined at a third angle θ3 clockwise in plan view relative to the second direction Y. The fourth normal N4, a straight line perpendicular to the fourth light-emitting surface EM4, extends in a direction different from the first direction X, the second direction Y, and the third normal N3. The fourth normal N4 is inclined at a fourth angle θ4 counterclockwise in plan view relative to the second direction Y. Both the third angle θ3 and the fourth angle θ4 are greater than 0 degrees and less than or equal to 45 degrees. In one example, the third angle θ3 and the fourth angle θ3 are equal to each other.

In the example illustrated, the third normal N3 is inclined toward the left side of the display device DSP, and the third light-emitting surface EM3 faces the left side of the display device DSP. Further, the fourth normal N4 is inclined toward the right side of the display device DSP, and the fourth light-emitting surface EM4 faces the right side of the display device DSP.

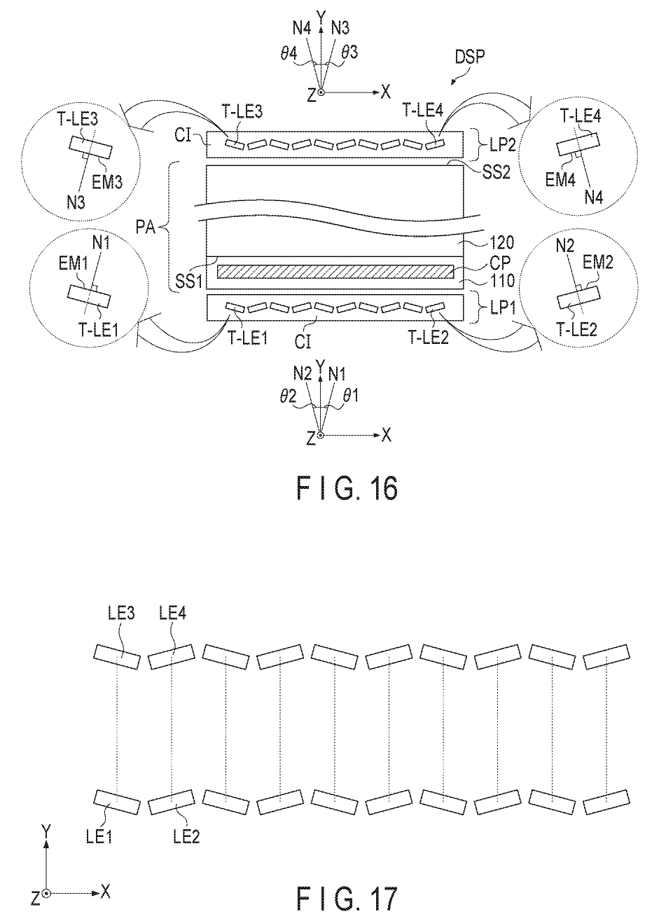

FIG. 16 is a partially enlarged view of the display device DSP shown in FIG. 15. With reference to FIG. 16, an example of the arrangement of light-emitting elements LE in the first light-emitting part LP1 and the second light-emitting part LP2 will be described in more detail.

As described above, in the first light-emitting part LP1, the first light-emitting elements LE1 and the second light-emitting elements LE2 are arranged alternately along the first direction to form a row. Similarly, in the second light-emitting part LP2, the third light-emitting elements LE3 and the fourth light-emitting elements LE4 are arranged alternately along the first direction, to form a row.

Now, let us focus on the light-emitting elements LE located at the respective ends of these rows. In the second light-emitting part LP2, the light-emitting element T-LE3 located at the left end of the row is one of the plurality of third light-emitting elements LE3. That is, the light-emitting element T-LE3 emits illumination light inclined to the left, directed from the left end of the display device DSP toward the display area DA. Further, the light-emitting element T-LE4 located at the right end of the row is one of the plurality of fourth light-emitting elements LE4. That is, the light-emitting element T-LE4 emits illumination light inclined to the right, directed from the right end of the display device DSP toward the display area DA.

In other words, as to the light-emitting element T-LE3, as the location progresses in the positive direction of the first direction X, the distance between the light-emitting surface and the second side surface SS2 decreases. For light-emitting element T-LE4, as the location progresses in the positive direction of the first direction, the distance between the light-emitting surface and the second side surface SS2 increases.

To put it another way, the light-emitting element T-LE3 faces the opposite side to the fourth light-emitting element LE4 adjacent thereto along the first direction X. Similarly, the light-emitting element T-LE4 faces the opposite side to the third light-emitting element LE3 adjacent thereto along the first direction X.

As mentioned earlier, the light-emitting element LE located at the left end of the row in the first light-emitting part LP1 is the first light-emitting element LE1. That is, said first light-emitting element LE1 (light-emitting element T-LE1) emits illumination light inclined to the right, directed from the left end of the display device DSP toward the display area DA. Further, the light-emitting element LE located at the right end of the row in the first light-emitting part LP1 is the second light-emitting element LE2. That is, said second light-emitting element LE2 (light-emitting element T-LE2) emits illumination light inclined to the left, directed from the right end of the display device DSP toward the display area DA.

In the example shown in FIG. 16, the first normal N1 is parallel to the third normal N3. Further, the second normal N2 is parallel to the fourth normal N4.

FIG. 17 is a diagram showing only the light-emitting elements LE extracted from the display device DSP shown in FIG. 15. With reference to FIG. 17, an example of the arrangement of the light-emitting elements LE in the first light-emitting part LP1 and the second light-emitting part LP2 will be explained in more detail.

As shown in FIG. 17, one of the first light-emitting elements LE1 faces one of the third light-emitting elements LE3 along the second direction Y. Further, one of the second light-emitting elements LE2 faces one of the fourth light-emitting elements LE4 along the second direction Y.

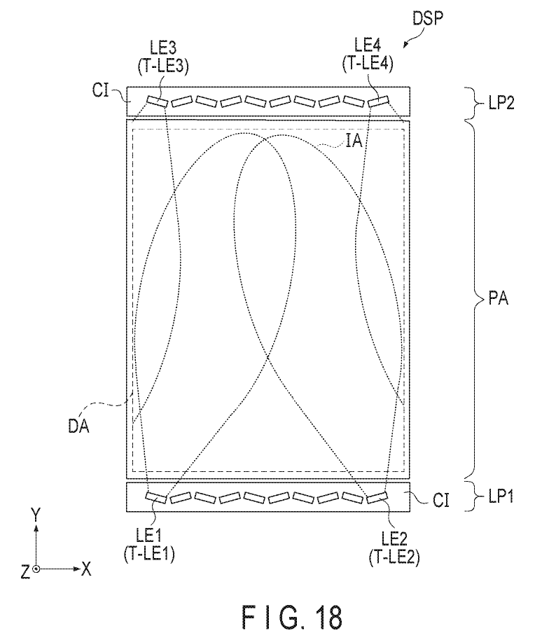

FIG. 18 is a schematic diagram showing the light-emitting elements T-LE1, T-LE2, T-LE3, and T-LE4 irradiating light onto the display panel PA in the display device DSP according to the third embodiment. In FIG. 18 the display panel PA is shown in a manner that the configuration thereof is partially omitted. In FIG. 18 , the irradiation area IA is represented by a dotted line. The irradiation area IA is the area illuminated by the illumination light emitted from light-emitting elements T-LE1, T-LE2, T-LE3, and T-LE4.

The display device DSP according to the third embodiment includes a second light-emitting part LP2. In this case, the display panel PA is illuminated with light from both the upper side and lower side. With this configuration, the unevenness in luminance in the vertical direction (second direction Y) of the display device DSP is mitigated.

The display device DSP according to the third embodiment includes a first light-emitting part LP1 and a second light-emitting part LP2. In the first light-emitting part LP1 and the second light-emitting part LP2, light-emitting elements LE inclined to the right (first light-emitting elements LE1 or fourth light-emitting elements LE4) and light-emitting elements LE inclined to the left (second light-emitting elements LE2 or third light-emitting elements LE3) are arranged alternately to form respective rows.

In the example shown in FIG. 18, the light-emitting element LE (light-emitting element T-LE3) of the left end of the second light-emitting part LP2 emits illumination light inclined to the left, directed toward the display area DA. With this configuration, it is possible to improve the brightness at the left end of the display device DSP. Further, in the example shown in FIG. 18, the light-emitting element LE (light-emitting element T-LE4) at the right end of the second light-emitting part LP2 emits illumination light inclined to the right, directed towards the display area DA. With this configuration, it is possible to improve the brightness at the right end of the display device DSP.

With the display device DSP according to the third embodiment, advantageous effects similar to those of the first embodiment can be achieved. Further, the display device DSP according to the third embodiment can improve the brightness uniformity of the displayed image in the vertical direction. Moreover, the display device DSP according to the third embodiment can improve the brightness uniformity of the displayed image in the horizontal direction.

### Fourth Embodiment

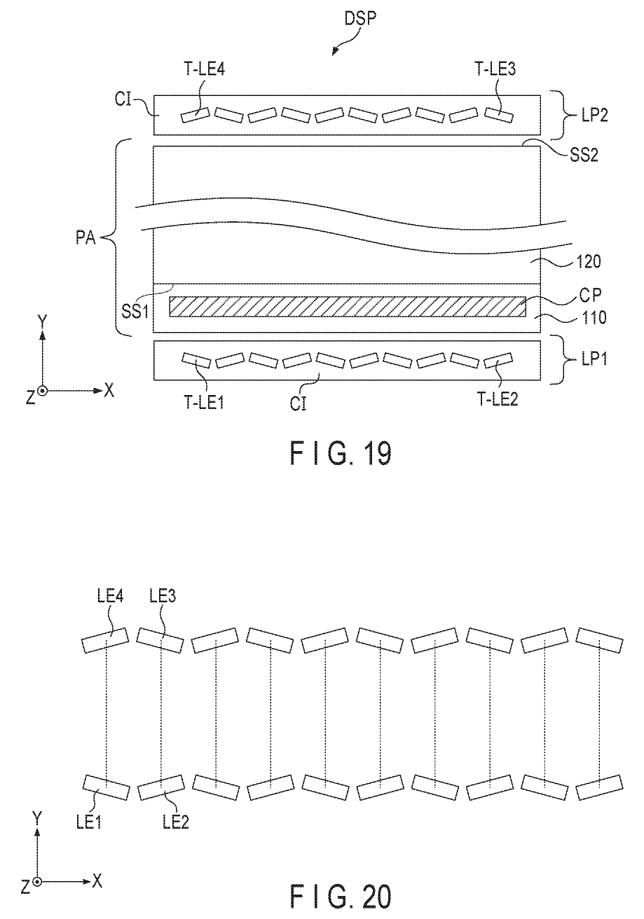

FIG. 19 is a plan view of a display device DSP according to the fourth embodiment. The display device DSP according to the fourth embodiment includes a first light-emitting part LP1 and a display panel PA, similar to those of the first embodiment. In FIG. 19, the display panel PA is shown in a manner that the configuration thereof is partially omitted. Further, the display device DSP according to the fourth embodiment further includes a second light-emitting part LP2 located on an opposite side to the first light-emitting part LP1 while interposing the display panel PA therebetween. The second light-emitting part LP2 includes a circuit board CI, a third light-emitting element LE3, and a fourth light-emitting element LE4, as in the case of the third embodiment.

The display device DSP according to the fourth embodiment is different from the display device DSP according to the third embodiment in that the light-emitting element LE located at the left end of the row in the second light-emitting part LP2 is one of the plurality of fourth light-emitting elements LE4. Specifically, this fourth light-emitting element LE4 (light-emitting element T-LE4) emits illumination light inclined to the right, from the left end of the display device DSP toward the display area DA.

Furthermore, the display device DSP according to the fourth embodiment is different from the display device DSP according to the third embodiment in that the light-emitting element LE located at the right end of the row in the second light-emitting part LP2 is one of the plurality of third light-emitting elements LE3. That is, this third light-emitting element LE3 (light-emitting element T-LE3) emits illumination light inclined to the left, from the right end of the display device DSP toward the display area DA.

In other words, as to the light-emitting element T-LE4, the distance between the light-emitting surface and the second side surface SS2 increases as the location progresses in the positive direction of the first direction X. On the other hand, as to the light-emitting element T-LE3, the distance between the light-emitting surface and the second side surface SS2 decreases as the location progresses in the positive direction of the first direction.

In other words, the light-emitting element T-LE4 faces the third light-emitting element LE3 adjacent thereto along the first direction X. Similarly, the light-emitting element T-LE3 faces the fourth light-emitting element LE4 adjacent thereto along the first direction X.

FIG. 20 is a diagram showing only the light- emitting elements LE extracted from the display device DSP shown in FIG. 19 With reference to FIG. 20,an example of the arrangement of light-emitting elements LE in the first light-emitting part LP1 and the second light-emitting part LP2 will be described in more detail.

As shown in FIG. 20, one of the first light-emitting elements LE1 faces one of the fourth light-emitting elements LE4 along the second direction Y. Further, one of the second light-emitting elements LE2 faces one of the third light-emitting elements LE3 along the second direction Y.

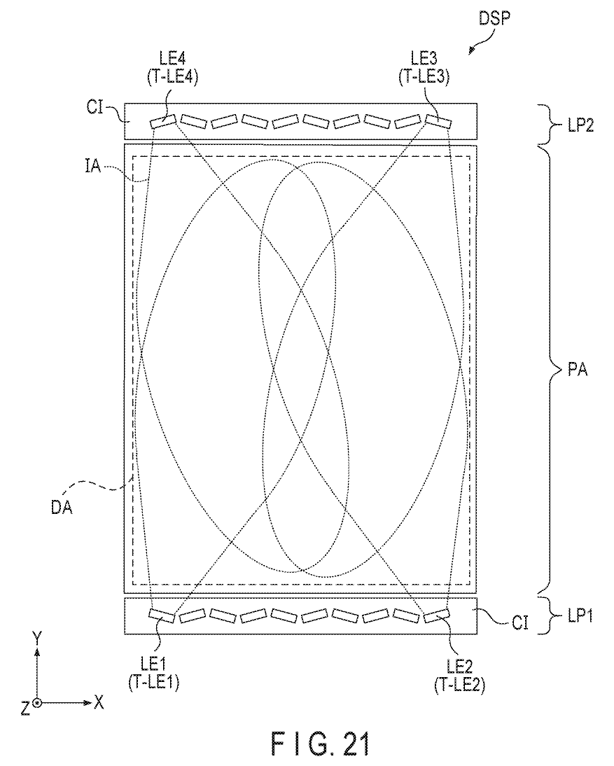

FIG. 21 is a schematic diagram showing the light-emitting elements T-LE1, T-LE2, T-LE3, and T-LE4 irradiating light onto the display panel PA in the display device DSP according to the third embodiment. In FIG. 21, the display panel PA is shown in a manner that the configuration thereof is partially omitted. In FIG. 21, the irradiation area IA is represented by a dotted line. The irradiation area IA is the area illuminated by the illumination light emitted from light-emitting elements T-LE1, T-LE2, T-LE3, and T-LE4.

In the example shown in FIG. 21 the light-emitting element LE (light-emitting element T-LE4) at the left end of the second light-emitting part LP2 emits illumination light inclined to the right toward the display area DA. That is, the most of the irradiation area IA of the light-emitting element T-LE4 is included within the display area DA of the display panel PA. Note that when the light-emitting element LE located at the left end of the row is the third light-emitting element LE3 instead of the fourth light-emitting element LE4 (the third embodiment), a part of the irradiation area IA of the light-emitting element LE located at the left end is not included within the display area DA (see FIG. 18). Therefore, compared to such a case, the display device DSP according to the fourth embodiment exhibits improved brightness.

Furthermore, in the example shown in FIG. 21, the light-emitting element LE (light-emitting element T-LE3) at the right end of the second light-emitting part LP2 emits illumination light inclined to the left toward the display area DA. That is, the most of the irradiation area IA of the light-emitting element T-LE3 is included within the display area DA of the display panel PA. Note that when the light-emitting element LE located at the right end of the row is the fourth light-emitting element LE4 instead of the third light-emitting element LE3 (the third embodiment), a part of the irradiation area IA of the light-emitting element LE located at the right end is not included within the display area DA (see FIG. 18). Therefore, compared to such a case, the display device DSP according to the fourth embodiment achieves improved brightness.

As described above, the display device DSP according to the fourth embodiment can efficiently illuminate the display area DA. Specifically, since the most of the illumination light emitted from the light-emitting elements LE located at the rightmost and leftmost ends of the display device DSP reaches the display area DA, the overall image brightness displayed is higher.

The third embodiment and the fourth embodiment can be appropriately selected as needed according to the specifications and applications of the display device DSP.

Based on the display devices described above as embodiments of the invention, a person having ordinary skill in the art may achieve display devices with arbitrary design changes; however, as long as they fall within the scope and spirit of the present invention, all of such display devices are encompassed by the scope of the present invention.

A skilled person would conceive various changes and modifications of the present invention within the scope of the technical concept of the invention, and naturally, such changes and modifications are encompassed by the scope of the present invention. For example, if a skilled person adds/deletes/alters a structural element or design to/from/in the above-described embodiments, or adds/deletes/alters a step or a condition to/from/in the above-described embodiment, as long as they fall within the scope and spirit of the present invention, such addition, deletion, and altercation are encompassed by the scope of the present invention.

Furthermore, regarding the present embodiments, any advantage and effect those will be obvious from the description of the specification or arbitrarily conceived by a skilled person are naturally considered achievable by the present invention.

What is claimed is:

1. A display device comprising:
a display panel which displays images; and
a first light-emitting part which irradiates light onto the display panel,
wherein
the display panel comprises:
a first transparent substrate;
a second transparent substrate which overlaps the first transparent substrate;
a liquid crystal layer located between the first transparent substrate and the second transparent substrate and containing a polymer-dispersed liquid crystal;
a first wiring line located between the first transparent substrate and the liquid crystal layer and extending along a first direction; and
a second wiring line located between the first transparent substrate and the liquid crystal layer and intersecting the first wiring line,
the second transparent substrate includes a first side surface,
an edge of the first side surface, in plan view, extends along the first direction,
the first light-emitting part includes:
a plurality of first light-emitting elements each including a first light-emitting surface that emits light; and
a plurality of second light-emitting elements each including a second light-emitting surface that emits light,
the plurality of first light-emitting elements and the plurality of second light-emitting elements are arranged alternately along the first side surface,
a first normal of the first light-emitting surface extends in a direction different from both the first direction and a second direction perpendicular to the first direction, and
a second normal of the second light-emitting surface extends in a direction different from the first direction, the second direction, and a direction in which the first normal extends.

2. The display device of claim 1, wherein
the first normal is inclined at a first angle clockwise in plan view with reference to the second direction,
the second normal is inclined at a second angle counterclockwise in plan view with reference to the second direction, and
each of the first angle and the second angle is greater than 0 degrees and 45 degrees or less.

3. The display device of claim 2, wherein
the first angle is equal to the second angle.

4. The display device of claim 1, further comprising:
a light guide located between the first side surface and the first light-emitting part.

5. The display device of claim 4, wherein
the light guide includes a first light-entering surface parallel to the first light-emitting surface and a second light-entering surface parallel to the second light-emitting surface.

6. The display device of claim 1, wherein
the first light-emitting part further comprises a circuit board including a mounting surface on which the plurality of first light-emitting elements and the plurality of second light-emitting elements are mounted,
the mounting surface is perpendicular to the first light-emitting surface and the second light-emitting surface, and
mounting terminals for mounting the plurality of first light-emitting elements and the plurality of second light-emitting elements, respectively, are arranged in a zigzag pattern on the mounting surface.

7. The display device of claim 1, wherein
the first light-emitting part further comprises a circuit board including a mounting surface on which the plurality of first light-emitting elements and the plurality of second light-emitting elements are mounted,
the mounting surface comprises:
a first inclined surface on which the first light-emitting elements are mounted, and
a second inclined surface on which the second light-emitting elements are mounted,
the first inclined surface is parallel to the first light-emitting surface, and
the second inclined surface is parallel to the second light-emitting surface.

8. The display device of claim 1, further comprising:
a seal which seals the liquid crystal layer between the first transparent substrate and the second transparent substrate.

9. The display device of claim 1, further comprising:
a third transparent substrate located between the first transparent substrate and the second transparent substrate; and
a seal which seals the liquid crystal layer between the first transparent substrate and the third transparent substrate,
wherein
the third transparent substrate is adhered to the second transparent substrate.

10. The display device of claim 1, further comprising:
a second light-emitting part located on an opposite side to the first light-emitting part while interposing the display panel therebetween,
wherein
the second transparent substrate includes a second side surface located on an opposite side to the first side surface,
the second light-emitting part comprises:
a plurality of third light-emitting elements each including a third light-emitting surface that emits light, and
a plurality of fourth light-emitting elements each including a fourth light-emitting surface that emits light,
the plurality of third light-emitting elements and the plurality of fourth light-emitting elements are arranged alternately along the second side surface,
a third normal of the third light-emitting surface extends in a direction different from the first direction and the second direction, and
a fourth normal of the fourth light-emitting surface extends in a direction different from the first direction, the second direction, and a direction in which the third normal extends.

11. The display device of claim 10, wherein
the third normal is inclined at a third angle clockwise in plan view with reference to the second direction,
the fourth normal is inclined at a fourth angle counterclockwise in plan view with reference to the second direction, and
each of the third angle and the fourth angle is greater than 0 degrees and 45 degrees or less.

12. The display device of claim 11, wherein
the third angle is equal to the fourth angle.

13. The display device of claim 11, wherein
the first normal is parallel to the third normal, and
the second normal is parallel to the fourth normal.

14. The display device of claim 13, wherein
one of the plurality of first light-emitting elements faces one of the plurality of third light-emitting elements along the second direction, and
one of the plurality of second light-emitting elements faces one of the plurality of fourth light-emitting elements along the second direction.

15. The display device of claim 13, wherein
one of the plurality of first light-emitting elements faces one of the plurality of fourth light-emitting elements along the second direction, and
one of the plurality of second light-emitting elements faces one of the plurality of third light-emitting elements along the second direction.
